(19) United States
(12) Patent Application Publication
(10) Pub. No.: US 2026/0169895 A1
(43) Pub. Date: Jun. 18, 2026

(54) METHOD AND SYSTEM TO RECTIFY ERRONEOUS LOG-GENERATING STATEMENTS IN SOURCE CODE

(71) Applicant: Tata Consultancy Services Limited, Mumbai (IN)

(72) Inventors: Shruti Kunal KUNDE, Mumbai (IN); Mayank MISHRA, Mumbai (IN); Ravi Kumar SINGH, Mumbai (IN); Rekha SINGHAL, New York, NY (US); Manoj Karunakaran NAMBIAR, Mumbai (IN); Aditya KULKARNI, Mumbai (IN); Prathit MEHTA, Mumbai (IN)

(73) Assignee: Tata Consultancy Services Limited, Mumbai (IN)

(21) Appl. No.: 19/404,400

(22) Filed: Dec. 1, 2025

(30) Foreign Application Priority Data
Dec. 16, 2024 (IN) 202421099639

(51) Int. Cl. G06F 11/362

(52) U.S. Cl. CPC G06F 11/366

(57) ABSTRACT

This disclosure relates generally to method and system to rectify erroneous log-generating statements in source code. Source code logging is a practice widely adopted in several phases of software lifecycle. During software development log statements helps to verify and debug errors occurring in the software. The method of the present disclosure receives source code comprising one or more log statements generated during execution of log-generating source code expression. Further, a first LLM obtains the source code and fetches a distilled prompt generated for the source code from a second LLM. Further, the first LLM generate an analysis report with the one or more erroneous log statements. Finally, the analysis report is utilized to rectify one or more erroneous log statements in the source.

### PRIORITY CLAIM

This U.S. patent application claims priority under 35 U.S.C. § 119 to: Indian Patent Application number 202421099639 filed on Dec. 16, 2024. The entire contents of the aforementioned application are incorporated herein by reference.

### TECHNICAL FIELD

The disclosure herein generally relates to Generative Artificial Intelligence (GenAI) in source code logging, and, more particularly, to method and system to rectify erroneous log-generating statements in source code using Large Language Models (LLM).

### BACKGROUND

Recently enterprises confront challenges in managing complex software code to meet ever-growing demands of their customers. These software or source code form components of diverse applications and are usually deployed across multiple servers in a distributed manner employing remote API calls for communication. When application component crashes there occurs a threat to application reliability. This is remarkably true for modern microservices-based applications where poor software coding logging practices destroys debugging processes. Most of the times the only information available for debugging process is the logs generated by the software code. Generally, software code logs are indispensable for debugging deployed applications and especially during application crash. However, in big data environments poor logging practices can lead to high volume of log data that may overwhelm storage systems, potentially causing resource exhaustion leading to runtime application crashes.

Quality and clarity of log statements are critical for debugging deployed applications, especially during crashes. Unfortunately, developers may not consistently adhere to standard logging practices, leading to instances of “poor or erroneous” logging. Poor logging manifests in various forms, including but not limited to misplaced log statements, the inclusion of irrelevant or erroneous objects, inaccurately worded messages, exposing customers data, an excess or lack of log statements, and even their outright omission. These issues are not just inconveniences in big data environments, the sheer volume of poorly managed logs can cripple systems leading to significant downtimes and hampering the ability to resolve time-critical issues.

Considerably existing methods focusses on automatic generation of log statement and also explored the use of Text-To-Text-Transfer-Transformer (T5) models for auto-generating log statements. This approach subsequently enhanced to inter-method static contexts to create contextualized prompts for input into a large language model (LLM), thereby generating higher quality log statements. Additionally, in another method in-context learning is employed to ensure accurate insertion of autogenerated log statements in appropriate locations. However, these advancements utilizes specific dataset considering to be the ground truth raising concerns about validity of generated log statements. Several tools and methodologies have been developed over the years to address various challenges in the fields of source code analysis, vulnerability detection, and log management. While these tools or existing methods addresses specific aspects of source code analysis and anomaly detection, but lack in identifying poor logging practices within code bases, aiming to reduce the debugging effort during production.

### SUMMARY

Embodiments of the present disclosure present technological improvements as solutions to one or more of the above-mentioned technical problems recognized by the inventors in conventional systems. For example, in one embodiment, a system for rectifying erroneous log-generating statements in source code is provided. The system includes receiving by a first LLM a source code comprising one or more log statements, wherein the one or more log statements was generated during execution of log-generating source code expression. Further, the first LLM obtains a distilled prompt for the source code from a second LLM, wherein the second LLM is preconfigured with a set of preference records includes a one or more standard best practices for logging, one or more project specific requirements and a software language specific guidelines. Then, the first LLM applies one or more instructions of the distilled prompt on the source code to generate an analysis report with the one or more erroneous log statements. Finally, one or more erroneous log statements in the source is rectified using the analysis report.

In another aspect, a method for erroneous log-generating statements in source code is provided. The method includes receiving by a first LLM a source code comprising one or more log statements, wherein the one or more log statements was generated during execution of log-generating source code expression. Further, the first LLM obtains a distilled prompt for the source code from a second LLM, wherein the second LLM is preconfigured with a set of preference records includes a one or more standard best practices for logging, one or more project specific requirements and a software language specific guidelines. Then, the first LLM applies one or more instructions of the distilled prompt on the source code to generate an analysis report with the one or more erroneous log statements. Finally, one or more erroneous log statements in the source is rectified using the analysis report.

In yet another aspect, there are provided one or more non-transitory machine-readable information storage mediums comprising one or more instructions, which when executed by one or more hardware processors causes a method for erroneous log-generating statements in source code is provided. The method includes receiving by a first LLM a source code comprising one or more log statements, wherein the one or more log statements was generated during execution of log-generating source code expression. Further, the first LLM obtains a distilled prompt for the source code from a second LLM, wherein the second LLM is preconfigured with a set of preference records includes a one or more standard best practices for logging, one or more project specific requirements and a software language specific guidelines. Then, the first LLM applies one or more instructions of the distilled prompt on the source code to generate an analysis report with the one or more erroneous log statements. Finally, one or more erroneous log statements in the source is rectified using the analysis report.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 illustrates an exemplary system for rectifying erroneous log-generating statements in source code using a Large Language Model (LLM), according to some embodiments of the present disclosure.

FIG. 2 is a functional block diagram to rectify erroneous log-generating statements in source code using the system of FIG. 1, in accordance with some embodiments of the present disclosure.

FIG. 3 illustrates an example of a process flow for identifying the method which exhibits erroneous log-generating statements in source code using the system of FIG. 1, in accordance with various embodiments.

FIG. 4 illustrates an web based GUI application to identify erroneous log-generating statements for the source code using the system of FIG. 1, in accordance with various embodiments.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

### Glossary

As used herein the term “log-generating statements” refers to source code which creates log statements.

“Downtime” refers to a time period when something is not working.

“Log statements” refers to description of the source code which helps debugging.

In production environments where applications generate and process vast amounts of data, minimizing downtime is critical. However, in big data contexts, massive scale of log data can quickly overwhelm storage systems and consume excessive computational resources, exacerbating the challenge of maintaining system stability. Substandard logging practices intensify this problem by generating excessive, irrelevant, or poorly structured logs that hinder efficient detection and resolution of application crashes. However, the problem is not confined to individual projects, rather, it represents significant enterprise wide challenges must be addressed to prevent resource exhaustion, system crashes, and prolonged downtimes.

Embodiments herein provide a method and system for rectifying erroneous log-generating statements in source code. The system may be alternatively referred as source code log-generating system. To address erroneous logging practices problem of source or source code, the system 100 leverages the capabilities of GenAI (Large Language Models (LLMs), to proactively analyze, identify, and rectify poor logging practices in software code. The method of the present disclosure provides recommendations for adjustments in log generating code statement (rectifications, additions, removals), and is also capable of applying them to obtain code with optimal log statements as output. Additionally, the method does not require fine-tuning of LLMs and works by instructing the LLMs using a prompt based approach. The performance of method is compared with nine open-source codebases that have been annotated by industry practitioners for their logging practices. Notably, the method achieves comparable outcomes to human practitioners in optimizing log statements.

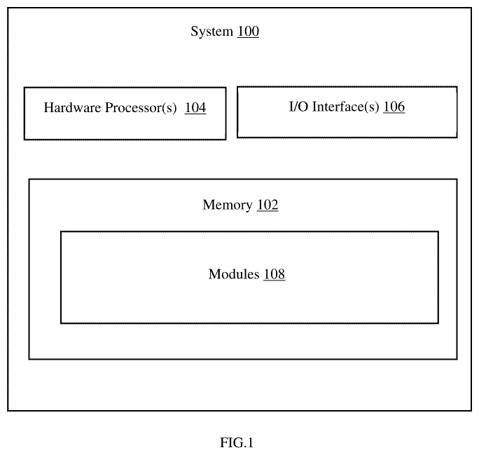

Moreover, it surpasses human capabilities by suggesting additional refinements for enhancing log-generating statements in codebases. The method provides advantage of automating generation of human-readable log messages, enhancing the interpretability and utility of log data for debugging and maintenance purposes. Moreover, unlike existing methods primarily the method focuses on access-deny log messages, applies proposed fixes and regenerates the code. Also, the method identifies and addresses multiple poor logging practices, providing a comprehensive solution for log management and debugging in production environments. The disclosed system is further explained with the method as described in conjunction with FIG. 1 to FIG. 3 below.

Referring now to the drawings, and more particularly to FIG. 1 through FIG. 4, where similar reference characters denote corresponding features consistently throughout the figures, there are shown preferred embodiments and these embodiments are described in the context of the following exemplary system and/or method.

FIG. 1 illustrates an exemplary system for rectifying erroneous log-generating statements in source code using a Large Language Model (LLM), according to some embodiments of the present disclosure. In an embodiment, the system 100 includes processor(s) 104, communication interface(s), alternatively referred as or input/output (I/O) interface(s) 106, and one or more data storage devices or memory 102 operatively coupled to the processor(s) 104. The system 100, with the processor(s) is configured to execute functions of one or more functional blocks of the system 100.

Referring to the components of the system 100, in an embodiment, the processor(s) 104 can be one or more hardware processors 104. In an embodiment, the one or more hardware processors 104 can be implemented as one or more microprocessors, microcomputers, microcontrollers, digital signal processors, central processing units, state machines, logic circuitries, and/or any devices that manipulate signals based on operational instructions. Among other capabilities, the processor(s) 104 is configured to fetch and execute computer-readable instructions stored in the memory. In an embodiment, the system 100 can be implemented in a variety of computing systems, such as laptop computers, notebooks, hand-held devices, workstations, mainframe computers, servers, a network cloud, and the like.

The I/O interface(s) 106 can include a variety of software and hardware interfaces, for example, a web interface, a graphical user interface, and the like and can facilitate multiple communications within a wide variety of networks N/W and protocol types, including wired networks, for example, LAN, cable, etc., and wireless networks, such as WLAN, cellular, or satellite. In an embodiment, the I/O interface(s) 106 can include one or more ports for connecting a number of devices (nodes) of the system 100 to one another or to another server.

The memory 102 may include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes.

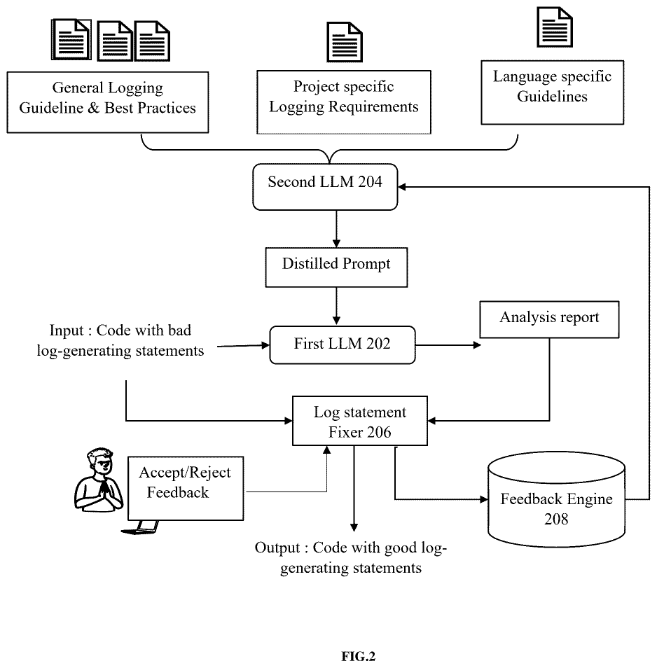

In an embodiment, the memory 102 includes a plurality of modules 108 can also include various sub-modules as depicted in FIG. 2. The plurality of modules 108 include programs or coded instructions that supplement applications or functions performed by the system 100 for executing different steps involved in the process of rectifying erroneous log-generating statements in source code. The plurality of modules 108, amongst other things, can include routines, programs, objects, components, and data structures, which performs particular tasks or implement particular abstract data types. The plurality of modules 110 may also be used as, signal processor(s), node machine(s), logic circuitries, and/or any other device or component that manipulates signals based on operational instructions. Further, the plurality of modules 108 can be used by hardware, by computer-readable instructions executed by the one or more hardware processors 104, or by a combination thereof.

The memory 102 may comprise information pertaining to input(s)/output(s) of each step performed by the processor(s) 104 of the system 100 and methods of the present disclosure.

FIG. 2 is a functional block diagram to rectify erroneous log-generating statements in source code using the system of FIG. 1, in accordance with some embodiments of the present disclosure.

Several works in literature have provided a quality criteria for source code logging, for example, the aspects related to readability of log statements, namely, Structure, Information and Wording. Structure pertains to the format and organization of words and variables in which a log message presents its information. The information denotes semantic content conveyed by the log message to record system execution behaviors. Wording involves lexical choice of words and punctuation used in the log message. While both aspects are crucial, greater weight is given to structure because it facilitates automated parsing, searching, and filtering of logs. The word source code may be alternatively referred as software code.

Well-structured software code log ensures essential information is consistently captured and easily retrievable, enabling efficient debugging and monitoring. Without consistent structure, even the most informative logs become more difficult to interpret and utilize effectively. Wordings are not considered as long as the correct information is conveyed in the log statements. Structure is given more weight than information. Table 1 mentions logging issues that are universally considered poor. First column “Problem Area” mentions broad area, such as, wrong severity, absence. The second column mentions exact problem. The third column describes “classification” of poor logging statements. The fourth column mentions rectification approach to fix poor logging. To classify one or more log-generating statements which do not have any problem the method of the present disclosure employs one more class named “Required” along with the classes mentioned in third column of Table 1.

TABLE 1
Existing logging issues

| Problem | Description of Bad | Classifi- | Rectification |
|---|---|---|---|
| area | logging practice | cation | approach |
| Absence | No timestamping logs | Absent | Include timing/ |
| | around external API | | timestamp |
| | | | information logs |
| | Absent log statement | | Introduce |
| | | | appropriate log |
| | | | statement with |
| | | | correct severity |
| Severity | Incorrect severity | Should be | Fix the severity |
| Information | Sensitive information | changed | Mask the sensitive |
| | in logs | | information |
| | Garbage content, | | Remove garbage |
| | wording issues | | content and |
| | | | appropriately phrase |
| | | | the information |
| | Verbose or too short | | Adjust the size |
| | (inadequate) | | |
| Placement | Incorrect place for | Should be | Should be removed |
| | logging | removed | & replaced at |
| | | | appropriate place |

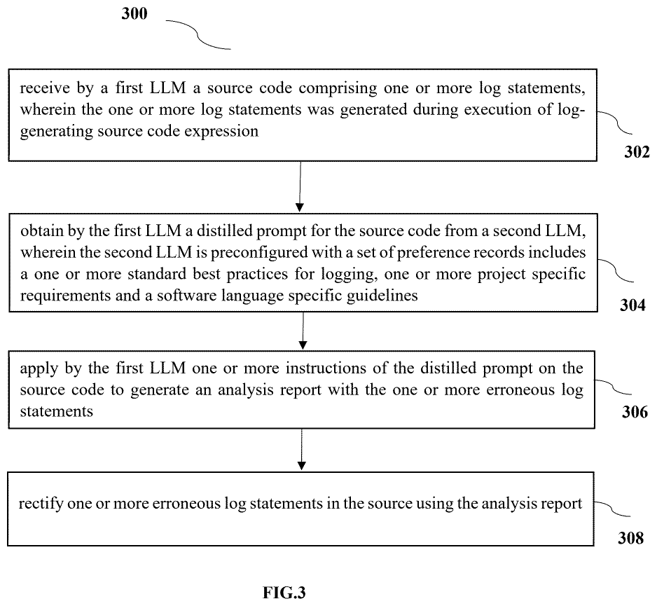

Functions of the components of system 100, to rectify erroneous log-generating statements in source code, are explained in conjunction with FIG. 2 and FIG. 3 providing flow diagram, architectural overviews, and performance analysis of the system 100.

Quality and quantity of logging practices are governed by project and application requirements. For example, a critical financial application requires extensive logging to capture the correctness and flow. Similarly, an online exam application requires capturing the time taken by external API calls like authentication to detect the bottlenecks.

The system 100 effectively addresses challenges originating from poor logging of source code and provides correct log statements by analyzing log generating statements in the software code. The system 100 considers context and recommends solutions to enhance logging practices. This improves reliability and clarity of log statements in production code of enterprise.

The method of the present disclosure customizes functioning based on project-specific needs having the capability to map universal classes to specific classes used in individual projects. For instance, in a particular dataset, each log statement in ground-truth are labeled for readability as either “adequate” or “erroneous”. The erroneously readable statements are further sub-classified into categories such as incorrect severity, incorrect language, or incorrect structure. This mapping allows to tailor unique logging practices of different projects enhancing its effectiveness and precision in improving logging practices across diverse environments.

As described, the FIG. 2 includes a first LLM 202, a second LLM 204, a log statement fixer 206 and a feedback engine 208. Referring to an example where the system 100 receives a source code comprising one or more log-generating statements for which erroneous log statements are identified and rectified with correct log statements. These correct log-generating statements helps proper execution of debugging statements.

Here, the first LLM 202 receives the software code as input, and the second LLM 204 obtains a distilled prompt corresponding to the software code.

The second LLM 204 generates the distilled prompt using a set of preference records. Further, the first LLM 202 applies the distilled prompt over the source code received as input and for which an analysis report is generated.

The log statement fixer 206 further provides rectification for the input source code and recommends correct logs which helps for debugging.

The feedback engine 208 feeds the distilled prompt to retrain the second LLM 204 to fine tune.

FIG. 3 illustrates an example of a process flow for identifying the method which exhibits erroneous log-generating statements in source code using the system of FIG. 1, in accordance with various embodiments. In an embodiment, the system 100 comprises one or more data storage devices or the memory 102 operatively coupled to the processor(s) 104 and is configured to store instructions for execution of steps of a method 300 by the processor(s) or one or more hardware processors 104. The steps of the method 300 of the present disclosure will now be explained with reference to the components or blocks of the system 100 as depicted in FIG. 1 through FIG. 2, and the steps of flow diagram as depicted in FIG. 3. Although process steps, method steps, techniques or the like may be described in a sequential order, such processes, methods, and techniques may be configured to work in alternate orders. In other words, any sequence or order of steps that may be described does not necessarily indicate a requirement that the steps to be performed in that order. The steps of processes described herein may be performed in any order practical. Further, some steps may be performed simultaneously.

Referring to the steps of the method 300, at step 302 a one or more hardware processor is configured to receive by a first LLM via one or more hardware processors, a source code comprising one or more log statements, wherein the one or more log statements was generated during execution of log-generating source code expression.

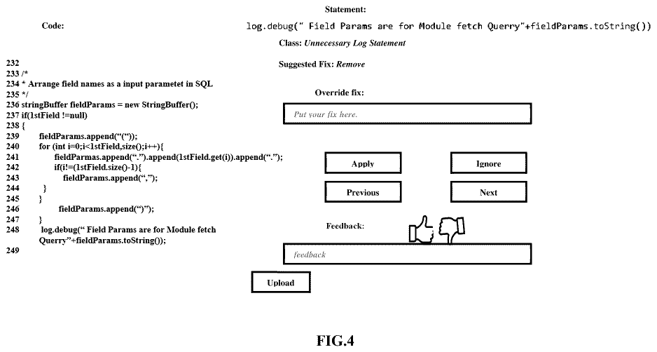

Referring to the example (Table 1) such as, an external API call placed just below a log statement notes the time becomes the context for the log statement. The user provides the example via the user interface web GUI as in FIG. 4. Another example of context is the object which the log statement is trying to print. If the log statement appears inside a loop then the loop is the context.

TABLE 1
source code with bad log-generating statements

| 232 | |
|---|---|
| 233 | /* |
| 234 | * Arrange field names as a input parametet in SQL |
| 235 | */ |
| 236 | stringBuffer fieldParams = new StringBuffer( ); |
| 237 | if(1stField != null) |
| 238 | { |
| 239 | fieldParams.append(“(“)); |
| 240 | for (int i=0;i<1stField,size( );i++){ |
| 241 | |
| fieldParmas.append(“.”).append(1stField.get(i)).append(“.”); | |
| 242 | if(i!=(1stField.size( )−1){ |
| 243 | fieldParams.append(“,”); |
| 244 | } |
| 245 | } |
| 246 | fieldParams.append(“)”); |
| 247 | } |
| 248 | log.debug(“ Field Params are for Module fetch |
| | Querry”+fieldParams.toString( )); |
| 249 | |

The user feeds the source code comprising one or more log statements via an web based GUI is supported. The user can either upload the code repository or copy-paste the software code to the display text box of the GUI of the first LLM 202 for analysis of the system 100. It is noted, the method is developed using Python language. Deployment of the web-based GUI is currently implemented using the “Streamlit” library (known in the art tool) of Python. The GUI backend as well as the logic module are currently hosted over an AWS instance running Ubuntu 22.04.

At step 304 of the method 300 the one or more hardware processors is configured to obtain by the first LLM a distilled prompt for the source code from a second LLM. The second LLM is preconfigured with a set of preference records comprising one or more standard best practices for logging, one or more project specific requirements and a software language specific guidelines.

Once the input is received by the first LLM, sequentially the second LLM 204 generates distilled prompt corresponding to the input as received. The software code may be python, java or the like. Initially, the second LLM 204 is already preconfigured with the set of preference records obtained from one or more external sources. The set of preference records includes one or more standard best practices for logging, one or more project specific requirements and a software language specific guidelines.

The distilled prompt includes one or more instructions is structured into three components. The first component compiles good logging practices sourced from websites, documents, blogs, tutorials, and course materials available across the internet. This component captures significant events, such as method entries, API calls, errors, system. This distilled prompt is improved periodically based on user feedback state obtained using the feedback engine 208 which changes to ensure comprehensive logging and avoiding logging sensitive data-including personal details, credentials, or financial information. Log messages should be descriptive and consistent, clearly detailing who, when, where, what, and the result. Some examples are—Use appropriate log levels: DEBUG for detailed development information, INFO for application progress, WARN for potential issues, ERROR for significant errors, and FATAL for critical failures that require immediate attention.

The second component incorporates project-specific logging guidelines provided by experts, which may include practices like ensuring that log messages in a specific project capture key metrics such as execution time for performance tracking.

The third component includes organization-specific logging practices that are unique which may involve adding metadata such as team identifiers or internal codes for compliance purposes. These components are combined to generate a comprehensive instruction prompt that also comprises of examples of poor logging practices and their corresponding fixes.

The second LLM 204 generates distilled prompt corresponding to the input prompt. Initially the second LLM obtains the set of preference records. The set of preference records includes one or more standard best practices for logging, one or more project specific requirements and a software language specific guidelines. Further, each log statement of the source code is normalized by extracting from each line of the source code corresponding entities of each log statement, wherein the entities includes a log level describing severity of the log, a timestamp, a message text, and a context. Then, one or more keywords are extracted from the normalized log statement of the source code by initially creating an empty list and for each log statement extract corresponding message text and tokenize the message text into individual words to identify part of speech tagging. Finally, one or more embeddings for each log statement is generated by capturing context from the one or more keywords which assists second LLM to interpret the log content.

Referring to the above example, Overuse of DEBUG Logs in Production: DEBUG logs are typically too verbose for production environments and can affect performance. For example, Change: logger. info (“Enter method calcSum with parameters: a=, b=”, a, b); To: logger.debug (“Enter method calcSum with parameters: a=, b=”, a, b);” This distilled prompt is used to identify and improve logging practices in the code base. The output is delivered in a structured JSON format, as shown in Table 3.

Further, at step 306 of the method 300 the one or more hardware processors is configured to apply by the first LLM one or more instructions of the distilled prompt on the source code to generate an analysis report with one or more erroneous log-generating statements. The analysis report displays each entry to the user for review, accept, modify, or reject each suggested fix.

Here, the first LLM 202 receives the distilled prompt and the input. Further, the distilled prompt is executed on the input software code. Here, the source code may include one or more erroneous logging software code which are further rectified with correct log statements of the source code.

For example, the first LLM 202 may be GPT-3.5 which is an advanced language model developed by OpenAI, designed to understand and generate human-like text. It builds upon the architecture of its predecessor, GPT-3 but features improvements in contextual understanding, reasoning, and accuracy. It is noted GPT-3.5 is trained on vast datasets excels in tasks such as answering questions, writing creative content, coding assistance, and engaging in detailed conversations. Its ability to process and generate coherent text makes it a versatile tool for applications ranging from education and business to creative writing and programming. Similar to first LLM 202, the second LLM 204 is also trained with be GPT-3.5.

Once the first LLM 202 executes the distilled prompt over the source code, the first LLM 202 generates an analysis report in the form of JSON file with one entry per log statement found in the code. Each entry in the analysis JSON comprises of the identified log statement, the line number of the log statement in the code, the classification of the log statement (classes “Should be changed”, “Should be removed”, and “Absent” as mentioned in Table 3). Additionally there is also a “Required” class which signifies that the identified log statement is already good and that no change is needed. The JSON entry also contains the rectification needed (in form of re-written log generating code) along with the reason why LLM believes the rectification is needed. A sample JSON entry is shown in Table 3,

TABLE 3
Analysis report Json file

49 {
50 “Logstatement”: “log.debug(\” Field Params are for Module fetch
Querry\” *fieldParams.toString( ));”,
51 “LineNumber :248,
52 “Classification” : “Should be removed”,
53 “Reason” “Similar to the previous log statement, it provides
information about a query that is not crucial for debugging.”
55 },

Finally at step 308 of the method 300 the one or more hardware processors is configured to rectify one or more erroneous log statements in the source using the analysis report.

The analysis report identifies erroneous log statements by incorrect Log, having original incorrect log statement, classification which indicates if the log should be changed, removed, etc, Reason which indicates explanation for why the log is classified as incorrect and suggests Fix with proposed correction or replacement for the log statement. Initially, the method initializes to create empty lists to bucket inti at least one of Accepted Fixes, Modified Fixes, and Rejected Fixes to categorize the user's decisions. For example, present each log issue to the user, for each entry E in R, display the details of E having original log statement Incorrect Log, Classification (Classification) and Reason (Reason), and Suggested fix (Suggested Fix).

The analysis report provides recommendation/rectification based on user inputs. he analysis report includes analysis and suggestions generated by the LLM are applied to the log-generating statements in a user monitored manner. The user is shown poor log generating statement, the rectification provided and the reason why the rectification is needed. The user can accept the change or suggest a newer statement. User can also provide feedback which is collected in the feedback engine 208 to be used to modify the distilled prompt for the future. The collected feedback is crucial to further improve the performance of the method.

In another embodiment, the method allows to obtain feedback provided by the user using the feedback engine 208 to act on the analysis report. Here, for each log statement the user shall provide Action taken (Accepted, Modified, Rejected), User feedback (optional). Further, for each log statement the user modifies or rejects a proposed fix. The user feedback may store in structured format such as LogID: Unique identifier for the log statement, OriginalLog: original log statement, Action: Accepted, Modified, or Rejected, Reason: User-provided reason for modification or rejection, Feedback: Any additional suggestions or comments. User provided feedback are categorized into issues with incorrect classifications (e.g., “should be changed” misapplied), frequent reasons for rejecting or modifying fixes (e.g., improper log levels, unclear messages) and suggestions for additional guidelines or context.

Based on the user provided feedback the second LLM is modified to generate new distilled prompts. This helps to provide new or refined guidelines based on feedback which add rules to address commonly misclassified log statements. Finally, the updated prompt improves classification accuracy, quality of proposed fixes and user satisfaction.

In one embodiment, experimental results provides code-bases from 9 different Java projects identified. The smallest code-base in terms of Lines of Code (LOC) is Zookeeper with 97 Thousand lines, and the largest one was Elastisearch with 1.5 Million lines. The number of log statements (NOL) present in these codebases are also mentioned in the Table 4.

TABLE 4
Details of the code bases used for experimentation

| | Lines of Code | Num Log Stmts |
|---|---|---|
| Codebase | (LOC) | (NOL) |
| Karaf | 133K | 70 |
| Wicket | 216K | 413 |
| Zookeeper | 97K | 1,245 |
| JMeter | 143K | 1,848 |
| Kafka | 27K | 1,563 |
| Cassandra | 432K | 1,326 |
| Flink | 177K | 2,455 |
| Elasticsearch | 1.5M | 2619 |
| HBase | 1.26M | 5,524 |
| Total | 4.2M | 17,689 |

Out of the total 17, 689 Log statements present in these code-bases the human (industry practitioners) labeled ground truth available is for 2,702 of them. Each log statement in the ground-truth is labeled for readability as “adequate” or “erroneous”, where the erroneously readable statements are further sub-classified (incorrect severity, incorrect language, incorrect structure). Note that Log Sculptor classifies a log statement into four classes, namely, Required, Should be Changed, Should be Removed, Absent. Among these four classes we consider Required as an adequately readable log statement and should be changed as an erroneously readable log statement. The method classification process is highly granular, allowing precise identification of various logging issues. Furthermore, The method is adaptable to any dataset format or application, ensuring flexibility across different projects and environments.

For each system, a randomly sampled set of logging statements was selected for experimentation. Specifically, the sampling adhered to a 95% confidence level and a 5% confidence interval, resulting in a total of 2,702 logging statements. We categorize the code bases as small (less than 145K LOC), medium (145K to 500K LOC) and large (More than 500K LOC).

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments of present disclosure herein addresses unresolved problem of source code logging. The embodiment, thus provides method and system to rectify erroneous log-generating statements in source code. Moreover, the embodiments herein further provides advantages in a multi-agent setting, where multiple agents collaborate seamlessly to identify and rectify erroneous logging practices with minimal human intervention. The method provides cost-benefit trade-offs, highlighting the transformative role. This improves logging practices diverse software projects, demonstrating its efficacy and potential for automation in software development workflows.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g., any kind of computer like a server or a personal computer, or the like, or any combination thereof. The device may also include means which could be e.g., hardware means like e.g., an application-specific integrated circuit (ASIC), a field-programmable gate array (FPGA), or a combination of hardware and software means, e.g., an ASIC and an FPGA, or at least one microprocessor and at least one memory with software processing components located therein. Thus, the means can include both hardware means and software means. The method embodiments described herein could be implemented in hardware and software. The device may also include software means. Alternatively, the embodiments may be implemented on different hardware devices, e.g., using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor-implemented method to rectify erroneous log-generating statements in source code, the method comprising:
receiving by a first large language model (LLM) via one or more hardware processors, a source code comprising one or more log statements generated during execution of log-generating source code expression;
obtaining by the first LLM via the one or more hardware processors, a distilled prompt for the source code from a second LLM, wherein the second LLM is preconfigured with a set of preference records comprising one or more standard best practices for logging, one or more project specific requirements and a software language specific guidelines;
applying by the first LLM via the one or more hardware processors, one or more instructions of the distilled prompt on the source code to generate an analysis report with the one or more erroneous log statements; and
rectifying via the one or more hardware processors, one or more erroneous log statements in the source using the analysis report.

2. The processor-implemented method of claim 1, wherein the second LLM generates the distilled prompt by,
obtaining the set of preference records from one or more external sources;
normalizing each log statement of the source code by extracting from each line of the source code corresponding entities of each log statement, wherein the entities includes a log level describing severity of the log, a timestamp, a message text, and a context;
extracting one or more keywords from the normalized log statement of the source code by initially creating an empty list and for each log statement extract corresponding message text and tokenize the message text into individual words to identify part of speech tagging; and
generating one or more embeddings for each log statement by capturing context from the one or more keywords which assists second LLM to interpret the log content.

3. The processor-implemented method of claim 1, wherein the analysis report includes one or more classification of correct log statements indicating rectifications to be performed on erroneous statements of the source code, and replacing with one or more correct log statements.

4. A system, to rectify erroneous log-generating statements in source code comprising:
a memory storing instructions;
one or more communication interfaces; and
one or more hardware processors coupled to the memory via the one or more communication interfaces, wherein the one or more hardware processors are configured by the instructions to:
receive by a first LLM a source code comprising one or more log statements, wherein the one or more log statements was generated during execution of log-generating source code expression;
obtain by the first LLM a distilled prompt for the source code from a second LLM, wherein the second LLM is preconfigured with a set of preference records includes a one or more standard best practices for logging, one or more project specific requirements and a software language specific guidelines;
apply by the first LLM one or more instructions of the distilled prompt on the source code to generate an analysis report with the one or more erroneous log statements; and
rectify one or more erroneous log statements in the source using the analysis report.

5. The system of claim 4, wherein the second LLM generates the distilled prompt by,
obtaining the set of preference records from one or more external sources;
normalizing each log statement of the source code by extracting from each line of the source code corresponding entities of each log statement, wherein the entities includes a log level describing severity of the log, a timestamp, a message text, and a context;
extracting one or more keywords from the normalized log statement of the source code by initially creating an empty list and for each log statement extract corresponding message text and tokenize the message text into individual words to identify part of speech tagging; and
generating one or more embeddings for each log statement by capturing context from the one or more keywords which assists second LLM to interpret the log content.

6. The system of claim 4, wherein the analysis report includes one or more classification of correct log statements in code and rectifications to be performed on erroneous statements of the source code, and replacing with one or more correct log statements.

7. One or more non-transitory machine-readable information storage mediums comprising one or more instructions which when executed by one or more hardware processors cause:
receive by a first LLM a source code comprising one or more log statements, wherein the one or more log statements was generated during execution of log-generating source code expression;
obtain by the first LLM a distilled prompt for the source code from a second LLM, wherein the second LLM is preconfigured with a set of preference records includes a one or more standard best practices for logging, one or more project specific requirements and a software language specific guidelines;
apply by the first LLM one or more instructions of the distilled prompt on the source code to generate an analysis report with the one or more erroneous log statements; and
rectify one or more erroneous log statements in the source using the analysis report.

8. The one or more non-transitory machine-readable information storage mediums of claim 7, wherein the second LLM generates the distilled prompt by,
obtaining the set of preference records from one or more external sources;
normalizing each log statement of the source code by extracting from each line of the source code corresponding entities of each log statement, wherein the entities includes a log level describing severity of the log, a timestamp, a message text, and a context;
extracting one or more keywords from the normalized log statement of the source code by initially creating an empty list and for each log statement extract corresponding message text and tokenize the message text into individual words to identify part of speech tagging; and
generating one or more embeddings for each log statement by capturing context from the one or more keywords which assists second LLM to interpret the log content.

9. The one or more non-transitory machine-readable information storage mediums of claim 7, wherein the analysis report includes one or more classification of correct log statements in code and rectifications to be performed on erroneous statements of the source code, and replacing with one or more correct log statements.
